(19) United States
(12) Patent Application Publication
(10) Pub. No.: US 2014/0226161 A1
(43) Pub. Date: Aug. 14, 2014

(54) DENSITOMETER STEP TABLET

(71) Applicant: Bio-Rad Laboratories, Inc., Hercules, CA (US)

(72) Inventors: Jeff Blitstein, Folsom, CA (US); Keith Kotchou, Walnut Creek, CA (US); Kevin McDonald, Novato, CA (US)

(73) Assignee: Bio-Rad Laboratories, Inc., Hercules, CA (US)

(21) Appl. No.: 14/179,148

(22) Filed: Feb. 12, 2014

Related U.S. Application Data
(60) Provisional application No. 61/763,735, filed on Feb. 12, 2013.

(51) Int. Cl. G01N 21/59; G01N 21/55

(52) U.S. Cl. CPC G01N 21/5907; G01N 21/55
USPC 356/433; 356/445

(57) ABSTRACT

The present invention provides a transmissive density and/or reflective density reference step tablet and methods of using thereof for calibrating a densitometer or the like.

### CROSS-REFERENCE TO RELATED APPLICATIONS

This application claims priority to U.S. Provisional Application No. 61/763,735, filed Feb. 12, 2013, the disclosure of which is herein incorporated by reference in its entirety for all purposes.

### BACKGROUND OF THE INVENTION

Transmissive density or optical density (OD) represents the amount of light transmission through a given medium in a logarthmic scale, where 0.00 OD corresponds to 100% transmission with no absorption or blocking. Reflective density (RD) represents the amount of light reflection off the surface of a given medium in a logarthmic scale, where 0.00 RD is equivalent to 100% reflection with no absorption. Measurements of transmissive and reflective density can be made using, for example, a densitometer or a flat-bed scanner.

Standard densitometers use red, green and blue CCD technology for transmissive and reflective imaging of chromogenic samples at an optimal detection wavelength. Densitometers quantitate the samples' optical density and/or reflective density by comparing the readings of the samples to those of a reference step tablet. The step tablet calibrates the densitometer, thereby providing accurate and reproducible quantitation. There is a need for a step tablet with a dynamic detection range that includes a low OD range and/or a low RD range.

### BRIEF SUMMARY OF THE INVENTION

In some aspects, provided herein is the composition of a densitometer step tablet that includes an optical density (OD) calibrator having an OD calibration range comprising an optical density of less than 0.050 OD. The OD calibrator can include one or more OD reference materials having an optical density of less than 0.050 OD. In some embodiments, the OD calibrator comprises one or more OD reference material having an optical density of about 0.00 OD, 0.020 OD and/or 0.04 OD (e.g., 0.040 OD). In some aspects, the densitometer step tablet has an OD calibration range from about 0.00 OD to at least 3.00 OD. The OD reference material can include plastic film, photographic film or glass.

In some embodiments, the densitometer step tablet further comprises a reflective density (RD) calibrator having an RD calibration range comprising a reflective density of less than 0.05 RD. Alternatively, the RD calibrator has an RD calibration range that includes 0.00 RD. In some aspects, the RD calibration range is from about 0.00 RD to at least 2.05 RD. In some instances, the RD calibrator comprises at least one RD reference material having a reflective density of about 0.00 RD. In some embodiments, the RD reference material, is polyvinylidene fluoride (PVDF) membrane or nitrocellulose membrane.

In some embodiments, the reflective density calibrator has an RD calibration range from about 0.00 RD to at least 2.05 RD. In some embodiments, the reflective density calibrator comprises RD reference material selected from the group consisting of PVDF membrane, nitrocellulose membrane, high-gloss reflective paper, plastic, optically-coated glass, and combinations thereof.

In other aspects, provided herein is the composition of a densitometer step tablet that includes a reflective density (RD) calibrator having an RD calibration point of less than 0.05 RD. In some embodiments, the RD reference material is polyvinylidene fluoride (PVDF) membrane or nitrocellulose membrane. Alternatively, the RD calibrator has an RD calibration point of about 0.00 RD. In some aspects, the RD calibrator has an RD calibration range from 0.00 RD to at least 2.05 RD. In some instances, the RD calibrator comprises at least one RD reference material having a reflective density of about 0.00 RD, wherein the RD reference material is polyvinylidene fluoride (PVDF) membrane or nitrocellulose membrane.

In some embodiments of the present invention, the densitometer step tablet comprises an optical density calibrator having an OD calibration range comprising an optical density less than 0.050 OD and a reflective density calibrator having an RD calibration range comprising about 0.00 RD.

In another aspect, provided herein is a method for determining the optical density and/or reflective density of a sample using a flat-bed seamier or a densitometer. The method includes (a) measuring the light transmission and/or the light reflection of the densitometer step tablet of the present invention (e.g., the step tablet comprising an OD calibrator having an OD calibration range including an OD less than 0.050 OD and/or a RD calibrator having a RD calibration point of less than 0.05 RD); (b) measuring the light transmission and/or the light reflection of the sample; and (c) interpolating the optical density and/or reflective density of the sample from the calibrated optical densities and/or reflective densities of the densitometer step tablet. In some embodiments, the method also includes interpolating optical density of the sample when the density is between about 0.00 OD to about 0.050 OD. In some embodiments, the method also includes interpolating reflective density of the sample when the density it between about 0.00 RD to about 0.05 RD.

### BRIEF DESCRIPTION OF THE DRAWINGS

FIG. 1 is a top-view diagram of one example of the densitometer step tablet as described herein.

FIG. 2 is a top-view diagram of another example of the densitometer step tablet as described herein.

FIG. 3 is a top-view diagram of another example of the densitometer step et as described herein located in a densitometer.

### DETAILED DESCRIPTION OF THE INVENTION

I. Introduction

The inventors has been created an improved step tablet that contains reference materials of less than 0.050 OD and less than 0.1 RD, specifically 0.00 OD, 0.02 OD, 0.04 OD (e.g., 0.040 OD) and 0.00 RD. The reference material allows for more accurate measurement of the light transmissive and reflective properties of a sample in the low optical density and reflective density ranges.

II. Definitions

Further features, aspects, objects, and embodiments of the invention will be apparent from the descriptions that follow.

The term “a” or “an” is intended to mean “one or more.”

The term “comprise” and variations thereof such as “comprises” and “comprising,” when preceding the recitation of a step or an element, are intended to mean that the addition of further steps or elements is optional and not excluded.

The term “densitometer step tablet” refers to an apparatus with optically transmissive reference materials of known optical densities and/or optically reflective reference materials of known reflective densities. A step tablet refers to a plurality of spaced reference material of predetermined optical or reflective densities optionally arranged from low to high density.

The term “reflective density” or “RD” refers to the amount of light reflection off the surface of a sample. A reflective density of 0.00 RD corresponds to 100% light reflection and no light absorption.

The term “optical density” or “OD” refers to the amount of light transmitted through the surface of a sample. An optical density of 0.00 OD corresponds to 100% light transmission and no light absorption.

The term “calibration reference” or “calibration point” refers to a known optical or reflective density of a material that is associated with an intensity value measured using an optical instrument, such as a densitometer. The calibration reference can be used to determined the optical or reflective density of a sample measured using an optical instrument.

The term “sample” refers to material that is measured by a densitometer or flat-bed scanner. Non-limiting examples include a polyacrylamide gel, coomassie blue-stained gel, silver-stained gel, colorimetric blot, film-based chemiluminiscent blot, film-based chemiluminescent blot, autoradiogram, slide and photograph. A sample can have a plurality of transmissive and reflective densities, As an example, a coomassie blue-stained gel of proteins can have one protein band of a specific OD, a second protein band of a different OD, and another OD at a location on the gel free of protein.

III. Detailed Description of Embodiments

In some embodiments of the invention, the density step tablet comprises of a plurality of calibration reference materials arranged in a series from lowest OD to highest OD (e.g., an OD calibrator) and/or arranged in a series from lowest RD to highest RD (e.g., a RD calibrator) In one embodiment, the reference material is mounded or affixed onto polycarbonate such that light is allowed to be transmitted through or reflected by the reference material.

The OD calibrator can have, for example, an optical density of less than 0.050 OD. In some embodiments, the calibrator includes an optical density of 0.04 OD, 0.02 OD, or 0.00 OD. In some cases, the calibration range can be 0.00 OD to at least 3.0 OD. The OD calibrator can contain calibration reference materials of 0.00 OD, 0.02 OD, 0.04 OD (e.g., 0.040 OD), 0.050 OD and higher. In some embodiment, the OD calibrator contains calibration reference material of 0.00 OD, 0.02 OD, 0.050 OD and higher. Optionally, the OD calibrator contains calibration reference material of 0.02 OD, 0.04 OD, 0.05 OD and higher. The OD reference material of 0.00 OD, 0.02 OD and/or 0.04 OD can be located near the reference materials of 0.050 OD to at least 3.0 OD.

The calibration reference material of 0.00 OD can be, for example, bare glass. The calibration reference material of 0.02 OD can include photographic film, commercially-available overhead projector film, photocopier/printer transparency film (e.g., 3M Transparency Film for Color Laser Printers (Cat. No. CG3700) and Apollo Plain Paper Copier Transparency Film (Cat. No. VPP100C)), or any plastic sheet material having an equivalent optical transmission. Accurate measurements of optically transmission can be determined using NIST-traceable spectrophotometric measurement equipment. The calibration reference material of 0.04 OD or 0.040 OD can include plastic or photographic film.

In some embodiments, the density step tablet comprises reference material of 0.040 OD, which can be different than the reference material of 0.04 OD which includes 0.040 OD, 0.041 OD, 0.042 OD, 0.043 OD, 0.044 OD, 0.045 OD, 0.046 OD, 0.047 OD, 0.048 OD or 0.049 OD. The density step tablet can include the reference material of 0.05 OD, e.g., 0.050 OD, 0.051 OD, 0.052 OD, 0.053 OD, 0.054 OD, 0.055 OD, 0.056 OD, 0.057 OD, 0.058 OD or 0.059 OD. Alternatively, the density step tablet can include the reference material of 0.050 OD, which can be different than reference material of 0.05 OD. The difference between an OD of 0.040 and 0.04 or of 0.050 and 0.05 OD can be determined using NIST-traceable spectrophotometric measurement equipment. In some embodiments, the OD reference material includes a material with an OD equivalent to that of a Coomassie-stained polyacrylamide gel, silver-stained polyacrylamide gel, or an unstained polyacrylamide gel.

A step tablet as described herein can have a calibration range for OD, RD, or both. The RD calibrator can have, for example, an RD of less than 0.05 RD. In some cases, the calibration range can be 0.00 RD to at least 2.05 RD and contain calibration reference materials of 0.00 RD, 0.05 RD to 2.05 RD. The RD reference material of 0.00 RD can be located near the other RD reference material. The calibration reference material of 0.00 RD can be, for example, nitrocellulose membrane or polyvinylidene fluoride (PVDF) membrane or any material of equivalent reflective transmission. In some embodiments, the RD calibration reference material includes, but is not limited to, PVDF membrane, nitrocellulose membrane, high-gloss reflective paper, plastic, optically coated glass, and other reflective media. In other embodiments, the RD reference material includes a material used as Western blotting membrane or a photographic film.

In some embodiments, the transmission step tablet has a plurality of steps, e.g., 5, 10, 15, 20, 21, 23, 25, 26, 27, 28, 29, 30 or more steps. In some embodiments, each step has dimensions of about 6-10 mm wide, by about 10-15 mm in length. For instance, each step can have a width of about 6 mm to about 1.0 mm, e.g., 6.0 mm, 6.1 mm, 6.2 mm, 6.4 mm, 6.5 mm, 6.8 mm, 7.0 mm, 7.2 mm, 7.5 mm, 7.6 mm, 7.8 mm, 8.0 mm, 8.1 mm, 8.4 mm, 8.5 mm, 8.7 mm, 8.9 mm, 9.0 mm, 9.1 mm, 9.3 mm, 9.6 mm, 9.8 mm, or 10.0 mm. In some embodiments, each step has a length of 10-15 mm, e.g., 10, 11, 12, 13, 14, or 15 mm. In some embodiments, the transmission step tablet has a stepwise density increment of about 0.15 OD such that, e.g., steps beginning at 0.05 OD progressively increase to 0.20 OD, 0.35 OD, 0.50 OD, 0.65 OD to 3.05 OD, or more. As an illustrative example of one embodiment, the transmission step has a calibration range comprising 0.050 OD to 3.05 OD, wherein each step increases in density by 0.15 OD. For instance, a step of 0.05 OD is next to a step of 0.20 OD, which is next to a step of 0.35 OD, etc. In some embodiments, the transmission step tablet has a density increment of 0.02 OD whereby the calibration range comprises 0.00 OD and 0.02 OD. In other embodiments, the calibration range comprises 0.00 OD, 0.02 OD and 0.04 OD, whereby the density increment is 0.02 OD.

In some embodiments, the steps of the densitometer step tablet are arranged in an order of increasing OD or RD along a fixed axis (e.g., horizontal axis) and at the same plane along the opposite fixed axis (e.g., vertical). In some instances, there is a space between two adjacent steps. In other instances, there is no space between two adjacent steps.

In some embodiments, the reflective step tablet has a plurality of steps, e.g, 5, 10, 15, 20, 21, 23, 25, 26, 27, 28, 29, 30 or more steps. In some embodiments, each step has dimensions of about 6-10 mm wide, by about 10-15 mm in length. For instance, each step can have a width of about 6 mm to about 10 mm, e.g., 6.0 mm, 6.1 mm, 6.2 mm, 6.4 mm, 6.5 mm, 6.8 mm, 7.0 mm, 7.2 mm, 7.5 mm, 7.6 mm, 7.8 mm, 8.0 mm, 8.1 mm, 8.4 mm, 8.5 mm, 8.7 mm, 8.9 mm, 9.0 mm, 9.1 mm, 9.3 mm, 9.6 mm, 9.8 mm, or 10.0 mm. In some embodiments, each step has a length of 10-15 mm, e.g., 10, 11, 12, 13, 14, or 15 mm. In some embodiments, the reflective step tablet has a stepwise density increment of about 0.10 RD, such that, e.g., steps beginning at 0.05 RD progressively increase to 0.15 RD, 0.25 RD, 0.35 RD to 2.05 RD, or more.

in some embodiments, the steps of the densitometer step tablet are arranged in an order of increasing OD or RD along a fixed axis (e.g., horizontal axis) and at the same plane along the opposite fixed axis (e.g., vertical). In some instances, there is a space between two adjacent steps. In other instances, there is no space between two adjacent steps.

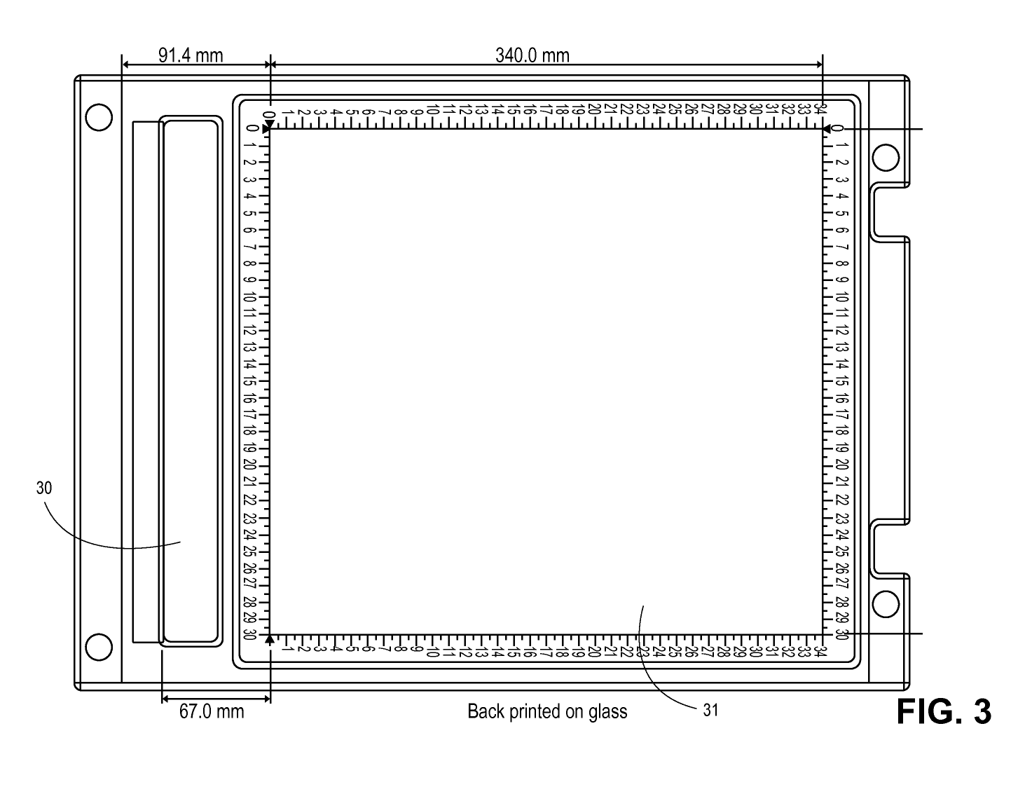

In some instances, the densitometer step tablet is located inside the optical instrument (see, e.g., FIG. 3). The densitometer step tablet can be affixed using adhesive to the under side of the glass platen or the primary scanning surface. In some embodiments, the densitometer step tablet is placed adjacent to the sample scanning area. in some instances, the densitometer step tablet is not part of the sample scanning area.

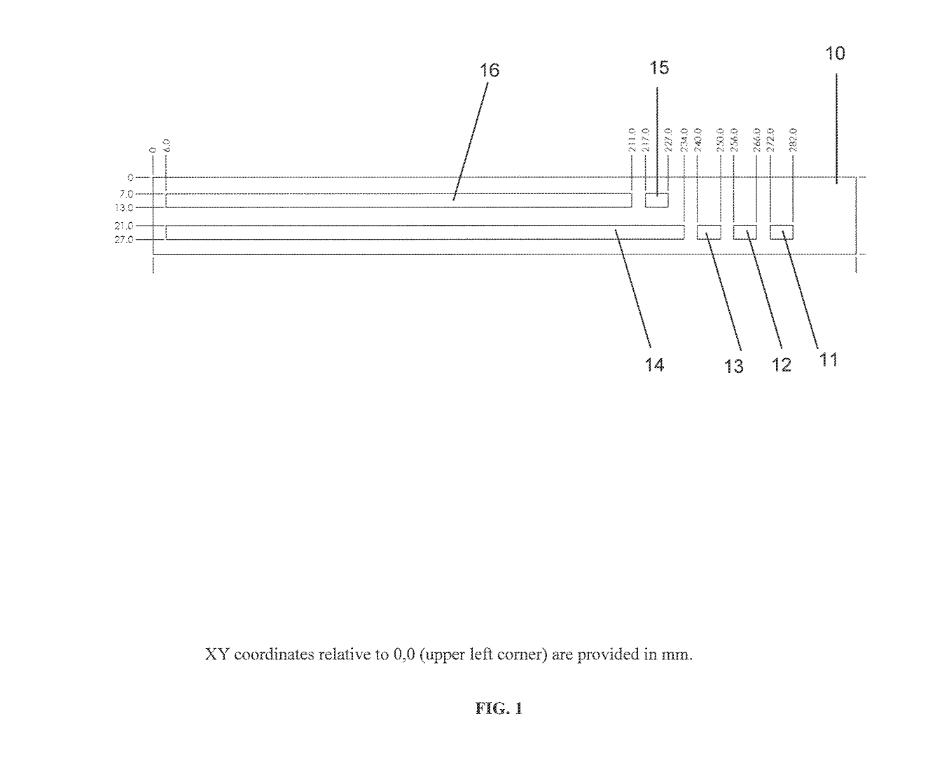

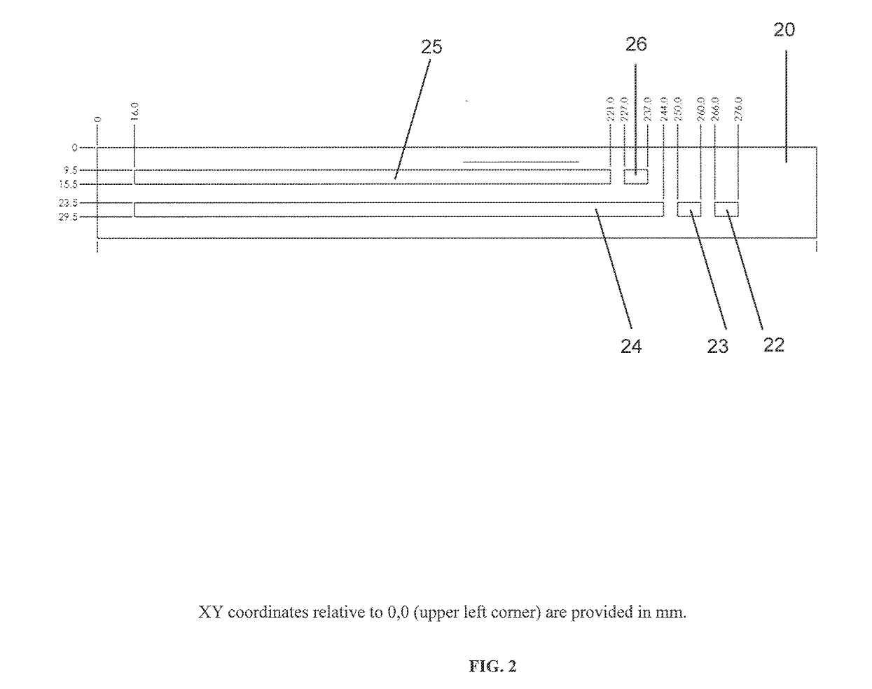

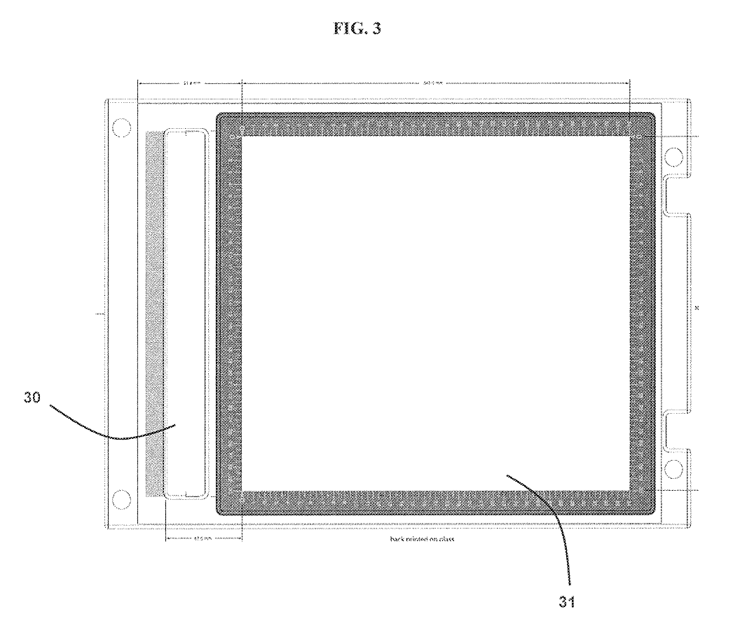

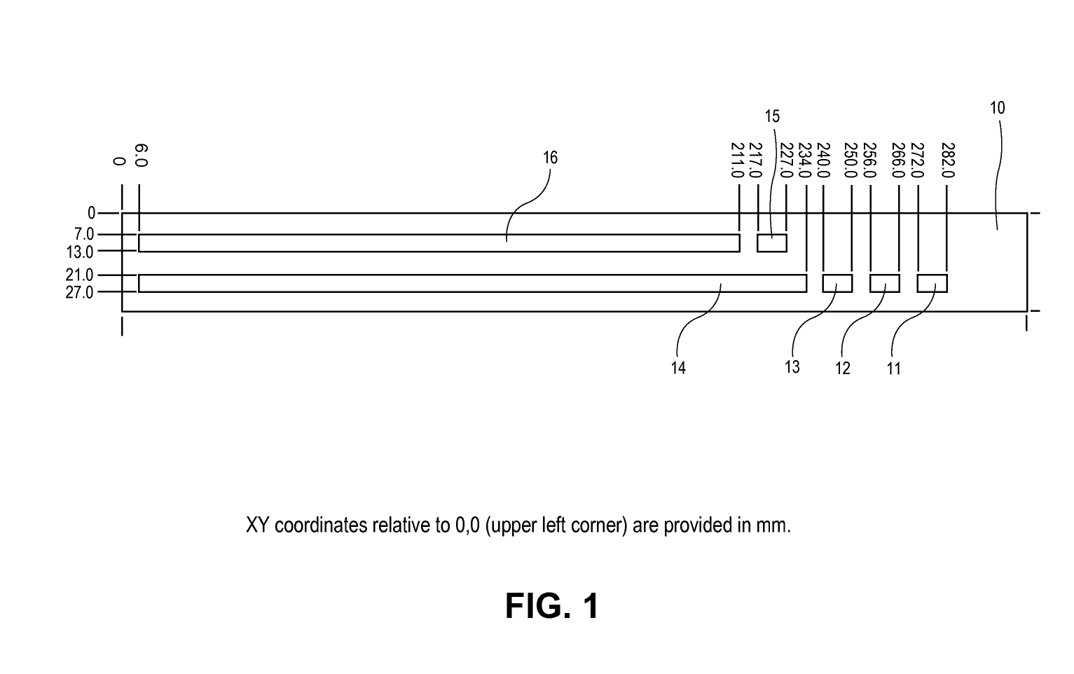

FIG. 1 is a top view diagram of a densitometer step tablet 10 representing one illustrative embodiment of the present invention. The step tablet has a 0.00 OD reference 11, a 0.02 OD reference 12, a 0.04 OD reference 13 and a OD reference step wedge of 0.050 to 3.0 OD with 21-steps and a density increment of 0.015 14, The RD reference step wedge 16 of 0.05 RD to 2.05 RD with a density increment of 0.05 is located above the OD reference step wedge and to the left of the 0.00 RD reference 15. The OD and RD reference materials are arranged in parallel and in decreasing density from left to right.

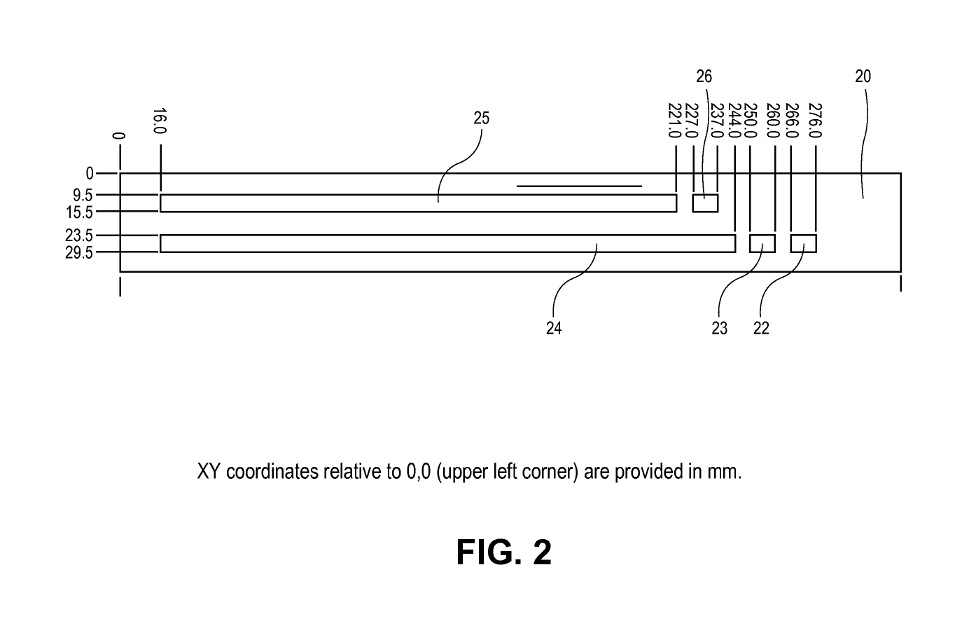

FIG. 2 is a top view diagram of a densitometer step tablet 20 representing another illustrative embodiment. The step tablet has a 0.02 OD reference 22, a 0.04 OD reference 23, a OD reference step wedge of 0.050 to 3.0 OD with multiple steps with a specific density increment 24, a RD reference step wedge of 0.05 RD to 2.0 RD 25, and a 0.00 RD reference 26. The OD and RD reference materials are arranged in parallel and in decreasing density from left to right.

FIG. 3 is a top view diagram of a densitometer step tablet 30 representing another illustrative embodiment in a densitometer. The step tablet is located adjacent to the primary sample scanning area 31 and affixed to the underside of the glass plate.

The densitometer step tablet described herein can be used with a flatbed scanner or a densitometer with a CCD camera. In some embodiments, the step tablet is scanned (e.g., using a CCD camera) to obtain intensity values (e.g., pixel values) for each color channel (e.g., red, green, and blue) independently for the measured colors. A calibration curve can be generated from a plot of intensity values versus reference ODs, such that the measured intensity values are associated (e.g., calibrated) to the reference optical and reflective densities of the step tablet. Next, a sample (e.g., a polyacrylamide gel, coomassie blue-stained gel, silver-stained gel, colorimetric blot, film-based chemiluminiscent blot, autoradiograms, slides and photographs) can be scanned in each color channel to measure intensity value(s) at the optimal detection wavelength. The calibration curve can be used to interpolate the measured intensity value(s) of the sample into optical and/or reflective density measurements. With this method, measurements of low density have increased accuracy because the low range ODs and RDs of the sample are interpolated, rather than extrapolated from the calibration curve. The step tablet, described herein, has advantages at least because calibration of low OD or RD can be achieved using interpolation (for example, the sample's intensity value is between. two standards on the step tablet) rather than requiring possibly less accurate extrapolation.

All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A densitometer step tablet comprising an optical density (OD) calibrator having an OD calibration range comprising an optical density less than 0.050 OD.

2. The densitometer step tablet of claim 1, wherein the OD calibrator comprises one or more OD reference material having an optical density of less than 0.050 OD.

3. The densitometer step tablet of claim 2, wherein the OD calibrator comprises one or more OD reference material having an optical density of 0.00 OD, 0.02 OD or 0.040 OD.

4. The densitometer step tablet of claim 2, wherein the OD reference material is plastic film, photographic film, or glass.

5. The densitometer step tablet of claim 1, wherein the OD calibrator has an OD calibration range from about 0.00 OD to at least 3.00 OD.

6. The densitometer step tablet of claim 1, further comprising a reflective density (RD) calibrator having an RD calibration range comprising a reflective density of less than 0.05 RD.

7. The densitometer step tablet of claim 6, wherein the RD calibrator comprises at least one RD reference material having a reflective density of about 0.00 RD, wherein the RD reference material is selected from a group consisting of polyvinylidene fluoride (PVDF) membrane and nitrocellulose membrane.

8. The densitometer step tablet of claim 6, wherein the RD calibrator has an RD calibration range from about 0.00 RD to at least 2.05 RD.

9. The densitometer step tablet of claim 6, wherein the RD calibrator comprises RD reference material selected from the group consisting of PVDF membrane, nitrocellulose membrane, high-gloss reflective paper, plastic, optically-coated glass, and combinations thereof.

10. A densitometer step tablet comprising a reflective density (RD) calibrator having an RD calibration point of less than 0.05 RD.

11. The densitometer step tablet of claim 10, wherein the RD calibrator has an RD calibration point of about 0.00 RD.

12. The densitometer step tablet of claim 10, wherein the RD calibrator has an RD calibration range from about 0.00 RD to at least 2.05 RD.

13. The densitometer step tablet of claim 10, wherein the RD calibrator comprises at least one RD reference material having a reflective density of about 0.00 RD, wherein the RD reference material is selected from a group consisting of polyvinylidene fluoride (PVDF) membrane or nitrocellulose membrane.

14. The densitometer step tablet of claim 10, wherein the RD calibrator comprises RD reference material selected from the group consisting of PVDF membrane, nitrocellulose membrane, high-gloss reflective paper, plastic, optically-coated glass, and combinations thereof.

15. A method of determining the optical density and/or reflective density of a sample using a flat-bed scanner or a densitometer comprising
(a) measuring the light transmission and/or light reflection of the densitometer step tablet of claim 1;
(b) measuring the light transmission and/or light reflection of the sample; and
(c) interpolating the optical density and/or reflective density of the sample from the calibrated optical density and/or reflective density of the densitometer step tablet.

16. The method of claim 15, further comprising interpolating optical density of the sample, wherein the optical density is between about 0.00 OD to about 0.05 OD.

17. The method of claim 15, further comprising interpolating reflective density of the sample, wherein the reflective density is between about 0.00 RD to about 0.05 RD.
